(19) United States
(12) Patent Application Publication
(10) Pub. No.: US 2003/0211298 A1
(43) Pub. Date: Nov. 13, 2003

(54) Multi-layer oriented polypropylene films with modified core

(76) Inventors: Robert A. Migliorini, North Haven, CT (US); David August Liestman, Shelton, CT (US)

Correspondence Address: ExxonMobil Chemical Company, P. O. Box 2149, Baytown, TX, 77522-2149, US

(21) Appl. No.: 10/418,999

(22) Filed: Apr. 18, 2003

Related U.S. Application Data
(63) Continuation-in-part of application No. 09/747,537, filed on Dec. 22, 2000.
(60) Provisional application No. 60/173,720, filed on Dec. 30, 1999.

(51) Int. Cl. B29D 9/00

(52) U.S. Cl. 428/195.1; 264/510

(57) ABSTRACT

A multilayer, oriented, polymeric film and the method for its manufacture are provided by the present invention. The film comprises a first and second skin layers, and a core layer comprising isotactic polypropylene, a polymeric modifier, and a hydrocarbon resin. A method for making the film of the present invention includes the steps of coextruding skin layers comprising heat sealable polymers and a core layer comprising isotactic polypropylene, a polymeric modifier, and a hydrocarbon resin; stretching the film in the machine direction, e.g., from about 4 to 7 times at low MDO temperatures; and stretching the film in the transverse direction, e.g., from about 6 to 11 times. Multi-layer clear biaxially shrinkable films with outstanding shrink properties and processability are provided. Additionally, white opaque-cavitated, coated, metallized, colored/tinted, reflective, and phosphorescent biaxially shrinkable films are provided. Furthermore, multilayer non-shrinkable films with very low melting point sealant resins are provided, and are advantaged by the novel combination of film composition of matter and method of manufacture.

### CROSS REFERENCE TO RELATED APPLICATIONS

This application is a Continuation-in-Part of U.S. patent application Ser. No. 09/747,537 and claims priority to U.S. Provisional Patent Application No. 60/173,720, filed Dec. 30, 1999.

### FIELD OF THE INVENTION

The present invention relates to the field of polyolefin films. It more particularly relates to multilayer oriented films having improved functionality, processability, film properties, and economics. More particularly, the present invention relates to oriented polyolefin films comprising a core blend of polyolefin, resin modifier and hydrocarbon resin, wherein said core blend gives novel and advantageous processing and film property attributes.

### BACKGROUND OF THE INVENTION

Heat sealable and shrinkable films are known in the art. Conventional heat sealable biaxially oriented films, however, are disadvantaged by the choice of sealant layer resins that may be processed on conventional biaxial orientation film tentering lines. In particular, sealant layer resins with a low melting point are difficult to process through the machine direction orienter (MDO) because of sticking of the film to the surface of the heated rolls. Heated rolls are used in the MDO to heat the film to a temperature sufficient to stretch it in the machine direction without incurring film breaks due to excessive stress. Typically, the melting point of the sealant layer resin is limited by the temperature needed to sufficiently preheat the core layer polymer of the film prior to stretching longitudinally.

For example, in some biaxially oriented polypropylene (BOPP) film production, the MDO may heat the sealable skin layer to a temperature of 116-138° C. prior to machine direction stretching. Sealant layer resins having melting points below 116° C. are very difficult to process on BOPP films due to sticking on MDO rolls at typical roll temperatures utilized. If roll temperatures are lowered much below 116° C., the draw stress on the film during machine direction stretching is excessive and results in a greater likelihood of film breaks during stretching resulting in costly line down time.

Conventional heat sealable biaxially oriented films are also sometimes disadvantaged by the thickness of the sealant layer resins that may be processed on conventional biaxial orientation film tentering lines. In particular, films with thick skin layers comprising sealable resins may be more difficult to process through the MDO because of the greater propensity of the film to stick to the surface of the heated rolls. Sealable skin layers of increased thickness may provide for improved hermeticity in packages formed from such multilayer films. Improved package hermeticity improves the shelf life of the package contents in gas-flush types of applications. If roll temperatures are lowered much below 116° C. to compensate for the sticking of the skin layer, the draw stress on the film during machine direction stretching is excessive and results in a greater likelihood of film breaks during stretching resulting in costly line down time.

Conventional shrink films have the disadvantages of high cost to produce and/or poor shrink performance. Conventional shrink films are also typically clear in appearance and are uncoated and unmetallized. These conventional shrink films are used predominately to over-wrap packages where a tight wrap is desired. The heat imparted to the shrink film during the package sealing process initiates the shrinkage of the films. Subsequent to over-wrapping the package with a shrinkable film, the package may be also passed through a shrink tunnel to impart additional heat to continue the shrinkage process for a longer time duration to yield an even tighter wrap of the film over the package.

U.S. Pat. No. 5,691,043 to Keller et al. discloses uniaxially shrinkable BOPP films comprising an isotactic polypropylene core layer and a polyolefin modifier for reducing the crystallinity of the crystalline polypropylene matrix polymer. The resulting film has high machine direction shrink and low transverse direction shrink by undergoing a second MD stretching process after the transverse direction stretching process. U.S. Pat. No. 5,691,043 is incorporated herein by reference in its entirety.

U.S. Pat. No. 5,667,902 to Brew et al. discloses high moisture barrier polypropylene-based films comprising a core blend of a highly crystalline, highly isotactic polypropylene, a conventional crystalline/isotactic polypropylene, and a resin modifier. The resulting non-shrinkable film is processed at typical stretching conditions on conventional biaxial orientation tentering lines and yields a film with low water vapor transmission. U.S. Pat. No. 5,667,902 is incorporated herein by reference in its entirety.

U.S. Pat. No. 5,443,895 to Peiffer et al. discloses multilayer transparent polyolefin films comprising a base layer comprising 5 to 40 wt % of a polypropylene homopolymer, 0 to about 30 wt % of a hydrogenated hydrocarbon resin, and about 30 to 95 wt % of an ethylene-propylene copolymer. The multilayer transparent films are stretched in the longitudinal direction at a stretching ratio less than 3, and in the transverse direction at a stretching ratio of more than 8. The resulting multilayer transparent films are shrinkable predominately in the transverse direction. U.S. Pat. No. 5,443,895 is incorporated herein by reference in its entirety.

### SUMMARY OF THE INVENTION

The present invention is directed to a multi-layer film comprising: (a) a first skin layer having a first side and a second side; (b) a core layer comprising polypropylene, a polymeric modifier, and a hydrocarbon resin wherein the core layer has a first side and a second side and the first side of the core layer is adjacent to the second side of the first skin layer; and (c) a second skin layer having a first side and a second side wherein the first side of the second skin layer is adjacent to the second side of the core layer. Some film embodiments according to this invention may also comprise a first transition layer exterior to the core layer and positioned on one side of the core layer, wherein the first transition layer is selected from the group consisting of isotactic polypropylene, EP random copolymer, PB copolymer, EP copolymer, hydrocarbon resins, and mixtures thereof. Still other embodiments may comprise a second transition layer positioned between the core layer and the second skin layer. In a particular embodiment of the invention, the core layer of the multi-layer film further comprises an additive selected from the group consisting of: (a) an opacifying agent selected from the group consisting of iron oxide, carbon black, aluminum, TiO2, and talc, said opacifying agent being present in said core layer in an amount ranging from about 1 wt % to about 15 wt %, based on the total weight of the core layer; (b) a cavitating agent selected from the group consisting of polybutylene terephthalate, nylon, solid glass spheres, hollow glass spheres, metal beads, metal spheres, ceramic spheres, and CaCO₃, said cavitating agent being present in said core layer in an amount ranging from about 1 wt % to about 20 wt %, based on the total weight of the core layer, said cavitating agent having a mean particle size in the range of from 0.1 micron to 10 microns; and (c) a specialty appearance-producing agent selected from the group consisting of coloring agents, phosphorescence producing agents, and reflective agents.

A further aspect of the present invention is directed to a method for manufacturing a multi-layer heat sealable polymeric film comprising the steps of: (a) coextruding a multilayer melt comprising a first skin layer; a core layer including isotactic polypropylene, a polymeric modifier, and a hydrocarbon resin; a first transition layer between the first skin layer and the core layer; and a second skin layer. Each of the first and second skin layers may comprise a heat sealable polymer with a melting point below 120° C.; (b) quenching the multilayer melt on a water-cooled casting roll to form a multi-layer cast sheet; (c) stretching said multi-layer cast sheet in the machine direction (MD) at roll temperatures below 120° C. from about 4 to about 7 times in the machine direction (MD) to form an MD stretched multi-layer heat sealable polymeric film; (d) stretching said MD stretched multi-layer heat sealable polymeric film in the transverse direction (TD) from about 6 to about 11 times to form a biaxially stretched untreated multi-layer heat sealable polymeric film; (e) thereafter surface treating at least one outermost surface of said biaxially stretched untreated multi-layer heat sealable polymeric film with a procedure selected from the group consisting of corona treatment, flame treatment, and plasma treatment, to form the multi-layer heat sealable polymeric film; and (f) winding said multi-layer heat sealable polymeric film onto a reel. The multi-layer heat sealable polymeric film may be coated on at least one outermost surface.

It is an object of the present invention to provide sealable films with improved sealability performance.

It is another object of the present invention to provide shrinkable films with improved manufacturing economics.

It is a further object of the present invention to provide shrinkable films having unique aesthetic properties.

It is a feature of the present invention to provide a core layer of the film which comprises a blend of a highly crystalline polypropylene homopolymer, and at least one resin modifier, and a hydrocarbon resin, such that the film may be stretched at temperatures lower than conventional BOPP stretching temperatures.

It is another feature of the present invention to provide skin layers of the multi-layer film which comprise heat sealable polyolefins with melting points lower than conventional BOPP sealant layers.

It is yet another feature of the present invention to provide a multi-layer, heat sealable film with a minimum seal initiation temperature lower than conventional BOPP films.

It is still another feature of the present invention to provide skin layers of the multi-layer film with thickness' greater than conventional BOPP sealant layers.

It is a further feature of the present invention to provide a multi-layer, shrinkable clear or white opaque film with high shrinkage levels in both the machine and transverse directions.

It is another feature of the present invention to provide a multi-layer, shrinkable metallized, coated, colored or tinted, reflective, and/or phosphorescent film with high shrinkage levels in both the machine and transverse directions.

It is yet another feature of the present invention to provide a multi-layer, heat sealable film with improved package hermeticity in gas flush packaging applications.

It is also another feature of the present invention to provide a multi-layer, heat scalable film with improved resistance to water vapor transmission.

It is a feature of the present invention to provide a multi-layer, heat sealable film having improved stiffness, haze and gloss.

It is another feature of the present invention to provide a multi-layer, shrinkable, heat sealable film having improved shrink uniformity in machine and transverse directions.

An advantage of the present invention is that multi-layer, shrinkable, heat sealable films may have improved processability on conventional BOPP tentering lines.

Another advantage of the present invention is that multi-layer, shrinkable, heat sealable films may have lower raw material costs than conventional shrink films.

Another advantage of the present invention is that multi-layer, shrinkable, heat sealable films may have lower manufacturing costs relative to conventional shrink films. Another advantage of the present invention is that multi-layer, shrinkable, heat sealable films may be used to over wrap packages, such as cassette tapes, CD cases, and tobacco boxes, at higher than conventional packaging speeds. The multi-layer films of the present invention are particularly suitable for use in packaging and labeling applications. The multi-layer films have excellent: (a) mechanical properties; (b) greater than 20% overall area reduction shrinkage at 135° C.; (c) slip properties for high-speed packaging applications; and (d) sealability.

### BRIEF DESCRIPTION OF THE DRAWINGS

FIG. 1 depicts a schematic of a cross-section of a three-layer polyolefin film with a modified core for an embodiment of the present invention.

FIG. 2 depicts a schematic of a cross-section of a four-layer polyolefin film with a modified core for an embodiment of the present invention, employing a first transition layer between the core layer and a first skin layer.

FIG. 3 depicts a schematic of a cross-section of a five-layer polyolefin film with a modified core for an embodiment of the present invention, employing a first transition layer between the core layer and a first skin layer, and a second transition layer between the core layer and a second skin layer.

### DETAILED DESCRIPTION OF THE INVENTION

The multilayer films of the present invention are distinguishable from the prior art in having a combination of core layer components comprising crystalline PP homopolymer, a polymeric resin modifier, and a hydrocarbon resin that provide for improved processability, sealability, and/or shrinkability at lower raw material costs. Polymeric modifiers and hydrocarbon resins are significantly more expensive than crystalline PP homopolymer. The hydrocarbon resin is generally the most costly of the three core layer components. The polymeric modifier functions to disrupt the crystallinity of the PP core layer to permit lower stretching temperatures in the longitudinal and transverse directions necessary for the use of low melting point skin layers, and/or the ability to obtain high film shrinkage in the MD and TD directions. The hydrocarbon resin functions to offset the negative impact of the polymer modifier on film tensile properties, optical properties, barrier properties, and processability (web breaks during low temperature stretching). The combination of polymer modifier, and hydrocarbon resin at combined weight percentages of 30% or less in a PP homopolymer core layer when oriented at lower than conventional stretching temperatures provides for multilayer films with improved shrinkability, machinability, and sealability at superior economics to those disclosed in the prior art. Lower melting point skin layers, which cannot be typically utilized at conventional machine direction (MD) stretching temperatures due to sticking to MDO rollers, yield multilayer films with significantly lower seal initiation temperatures relative to those disclosed in the prior art. Multilayer films with lower heat seal initiation temperatures correspondingly yield higher processing speed capability on film packaging equipment.

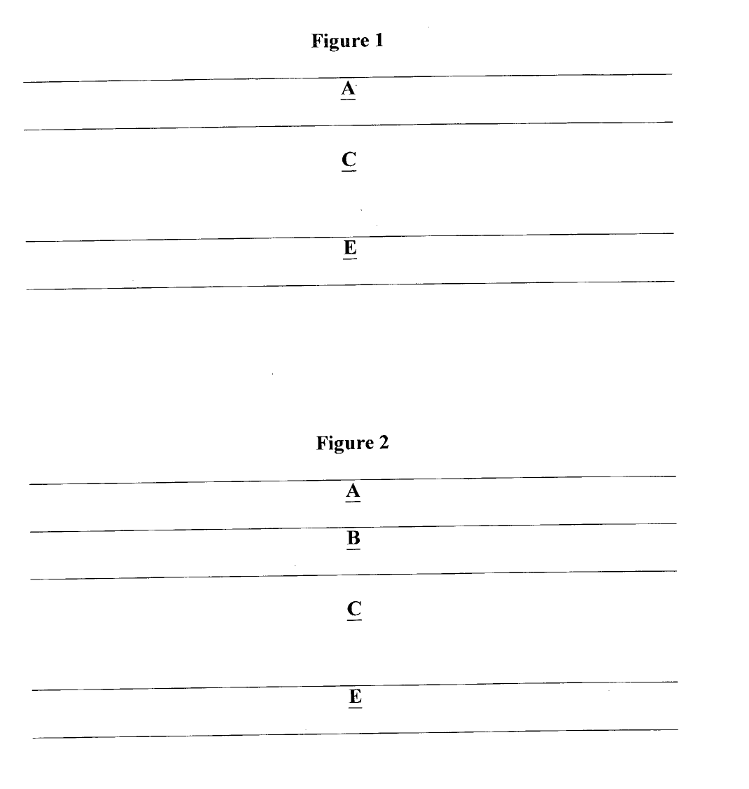

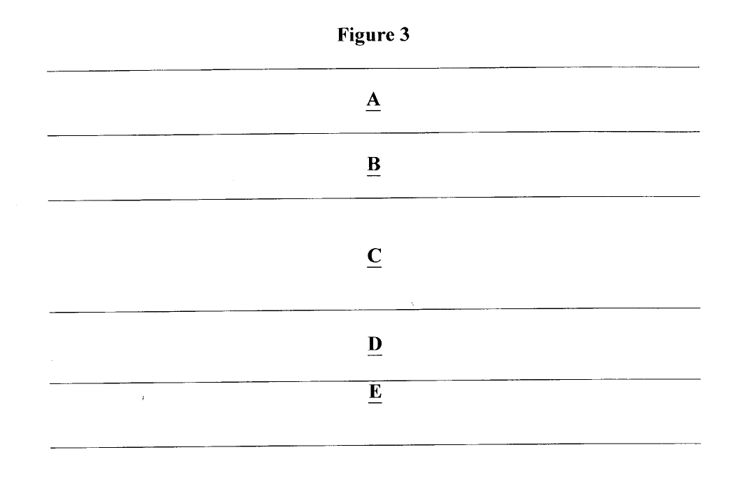

FIG. 1 depicts a cross-sectional view of a three-layer polyolefin film according to the present invention having a modified core. In its simplest form, there is a core layer C, a first skin layer A on one side of the core layer C, and a second skin layer E on the opposite side of the core layer C. Additionally, an optional first transition layer B may be interposed between the first skin layer A and the core layer C as depicted in FIG. 2 for a four-layer polyolefin film with modified core. Furthermore, an optional second transition layer D may be interposed between the core layer C and the second skin layer E as depicted in FIG. 3 for a five-layer polyolefin film with modified core.

Core Layer C

The core layer C material may comprise a blend of an isotactic polypropylene (a) with one or more resin modifiers (b), and a hydrocarbon resin (c). Resin modifiers are defined as polyolefin materials which are less crystallizable than isotactic polypropylene because of a higher degree of chain imperfections resulting in lower isotacticity.

Suitable resin modifiers (b) for use in the present invention include polyolefins other than isotactic polypropylene. The resin modifier may be selected from the group consisting of atactic polypropylene, syndiotactic polypropylene, ethylene-propylene copolymer, propylene-butylene copolymer, ethylene-propylene-butylene terpolymer, polybutylene, and linear low density polyethylene.

Isotactic polypropylene (a), e.g., polypropylene having less than 15% atacticity, may be combined with a modifier, e.g., atactic polypropylene, in the present core layer C. Atactic content may be measured by a polymer's insolubility in boiling n-hexane with chain imperfections being observed via NMR tests. The polypropylene matrix polymer (a) may have an isotacticity of between 85% to 95%, preferably between 87% to 93%, and still more preferably between 90% to 92%, as measured by C13 NMR. The isotactic polypropylene polymer may have a melt flow (measured in accordance with the standard ASTM D1238 method) ranging from about 1.2 to about 10 g/10 minutes, and preferably from about 2.5 to about 6 g/10 minutes. Ziegler-Natta catalyzed polypropylenes are preferred to metallocene catalyzed polypropylenes due to the broader molecular weight distribution and low isotacticity levels achievable.

Commercially available isotactic polypropylene suitable for use in the present invention includes 3371 from AtoFina Oil and Chemical Company, Chemical Division, Dallas Tex. Atactic polypropylenes which are commercially available include L1300 from Novolen of BASF Corporation, Parsippany, N.J.

In another embodiment, the present invention comprises a core layer C which comprises polypropylene as described above, preferably isotactic polypropylene, mixed with polybutylene modifier to provide a core layer C containing, for example, 2 to 15 wt % polybutylene, and preferably, 5 to 10 wt % polybutylene. Suitable polybutylenes include PB 8430, available from Shell Chemical Company of Houston, Tex.

In yet another aspect of the invention, the core layer C includes polypropylene as described above, preferably isotactic polypropylene, mixed with ethylene-propylene copolymer modifier, e.g., 2 to 10 wt % ethylene-propylene copolymer, and preferably 4 to 8 wt % EP copolymer. Suitable EP copolymers may contain from 2 to 7 wt % ethylene, the balance being propylene. The copolymers may have a melt index at 230° C. generally ranging from 2 to 15, and preferably from 3 to 8. The crystalline melting point is usually from about 125° C. to about 150° C., and the number average molecular weight is about 25,000-100,000. The density may be from 0.89 to 0.92 g/cm3. Suitable EP copolymers include EP 8573, available from AtoFina Oil and Chemical Company, Chemical Division, Dallas, Tex.

In still another aspect of the invention, the core layer C may include a blend of polypropylene as described above, preferably isotactic polypropylene, mixed with, for example, 2 to 10 wt % ethylene-propylene copolymer, said ethylene-propylene copolymer preferably containing from 0.5 to 1 wt % ethylene, the balance being propylene. These fractional copolymers are commercially available containing 0.6 wt % ethylene (4173 from AtoFina).

In another aspect of the invention, the core layer C may comprise a blend of polypropylene as described above, preferably isotactic polypropylene, mixed with propylene-butylene copolymer. Suitable propylene-butylene copolymers include Cefor SRD4-105, and Cefor SRD4-104 available from Shell Chemical Company of Houston, Tex.

In yet another aspect of the invention, the core layer C may comprise a blend of polypropylene as described above, preferably isotactic polypropylene, mixed with linear low density polyethylene (LLDPE). These polymers may have a melt index of 1 to 10. The linear low density polyethylenes may have a density in the range of 0.88-0.94 g/cc, preferably from 0.89-0.92 g/cc. The linear low density polyethylenes may be derived from ethylene together with other higher comonomers such as butene-1, hexene-1 or octene-1. Commercially available LLDPEs include Exact 2009, Exact 2010, and Exact 3016 available from ExxonMobil Chemical Company of Houston, Tex.

In another embodiment, the core layer C may comprise a blend of polypropylene as described above, preferably isotactic polypropylene, mixed with syndiotactic polypropylene and, optionally, ethylene-propylene copolymer. Suitable EP copolymers are described above. The syndiotactic polypropylene may possess an isotacticity of less than 15%, and preferably less than 6%. Commercially available syndiotactic polypropylene resins include EOD 9306 and EOD 9502 available from AtoFina of Dallas, Tex.

In yet another aspect of the invention, the core layer C may comprise a blend of polypropylene as described above, preferably isotactic polypropylene, mixed with ethylene-propylene-butylene terpolymer as modifier. Suitable terpolymers include those containing 3 to 5 wt % ethylene and 3 to 6 wt % butylene. Such terpolymers are available from Chisso Corporation of Tokyo, Japan, under the tradename Chisso 7700 Series. Other suitable ethylene-propylene-butylene terpolymers include those containing 0.5 to 3 wt % ethylene, and 13 to 20 wt % butylene. Such terpolymers are available from Chisso, under the tradename Chisso 7800.

Suitable core layers C of the present invention may also include recycled polypropylene resin (RPP).

Examples of hydrocarbon resins (c), which may be used in the present core layer C, are described in U.S. Pat. No. 5,667,902. The resin modifier may be a low molecular weight hydrocarbon which is compatible with the polypropylene matrix polymer (a) and the polymeric resin modifier (b) and which provides the desired enhancement of film properties. The resin modifier may, optionally, be hydrogenated. The hydrocarbon resin may have a number average molecular weight less than about 5000, for example, less than about 2000, for example, from about 500 to 1000. The hydrocarbon resin may be natural or synthetic and may have a softening point of from about 60° C. to about 180° C. Particular hydrocarbon resins include among others petroleum resins, terpene resins, styrene resins and cyclopentadiene resins.

Examples of commercially available hydrogenated hydrocarbon resins are those sold under the trademarks PICCOLYTE, REGALREZ and REGALITE by Hercules Corporation of Wilmington, Del. and under the trademark ESCOREZ by ExxonMobil Chemical Company of Houston, Tex.

One particular hydrocarbon resin is referred to herein as a saturated alicyclic resin. The saturated alicyclic resins are obtained by the hydrogenation of aromatic hydrocarbon resins. The aromatic resins are themselves obtained by polymerizing reactive unsaturated hydrocarbons containing, as the principal component, aromatic hydrocarbons in which the reactive double bonds are generally in side-chains. More particularly, the alicyclic resins are obtained from the aromatic resins by hydrogenating the latter until all, or almost all, of the unsaturation has disappeared, including the double bonds in the aromatic rings.

The saturated alicyclic resins used in the present invention may have a softening point from about 85° C. to about 140° C. for example, from about 100° C. to about 140° C., as measured by the ball and ring method. Examples of commercially available saturated alicyclic resins are those sold under the trademark ARKON-P by Arakawa Forest Chemical Industries, Ltd. of Osaka, Japan.

In general terms, the core layer C may comprise 15 wt % or less of each of polymeric resin modifier (b) and hydrocarbon resin (c). Core layer C may contain, for example, from about 70 wt % to about 96 wt % of crystalline polypropylene matrix polymer (a). In a preferred embodiment of the present invention, the core layer C comprises up to about 10 percent by weight of polymeric modifier (b) and up to about 10 percent by weight of the hydrocarbon resin (c). For example, the core layer C may comprise from about 2 wt % to about 10 wt % of each of polymeric modifier (b) and hydrocarbon resin (c). In an even more preferable embodiment of the present invention, the core layer C comprises up to about 5 percent by weight of polymeric modifier (b) and up to about 5 percent by weight of the hydrocarbon resin (c). For example, the core layer C may comprise from about 2 to 5 wt % of each of polymeric resin modifier (b) and hydrocarbon resin (c). It will be understood that the optimum amount of a particular component to be chosen for a given film will depend upon the nature and amounts of the other components of the film. It will also be understood that the above-mentioned weight percentages are all based on the entire weight of core layer C. The core layer C may have a thickness in the range of from about 8 to 71 microns, preferably 10 to 40 microns, and more preferably from 12 to 30 microns.

Skin Layers (A and E)

The skin layers (A and E) may be coextruded from low melting point polyolefin resins. MDO stretching temperatures may be correspondingly decreased below levels typically used in producing conventional heat sealable BOPP films.

The composition of the skin layer (A and E) is selected to provide desirable heat seal characteristics, especially at relatively low heat seal temperatures. Examples of skin layer (A and E) polyolefins are, but not limited to, metallocene catalyzed linear low density polyethylene (LLDPE) and high butene-1 containing copolymers, random copolymers of propylene and ethylene (EP copolymers), random copolymers of propylene and butene-1 (PB copolymers), and random terpolymers, such as a terpolymer of ethylene, butene-1 and polypropylene (EPB terpolymers).

EP random copolymers that may be used for the skin layers (A and E) of the present film are ethylene-propylene random copolymers containing from about 1.5 to about 10, and preferably from about 3 to about 7 weight percent ethylene.

EPB terpolymers that may be used for the skin layers (A and E) of the present film are ethylene-propylene-butene terpolymers containing from about 1 to about 10, and preferably from about 2 to about 6 weight percent ethylene and from about 80 to about 97, and preferably from about 88 to about 95 weight percent propylene.

PB copolymers that may be used for the skin layers (A and E) of the present film are propylene-butene-1 copolymers containing from about 5 to about 20 wt % butene-1, and preferably from about 7 to 15 wt % butene-1.

The EP and PB copolymers, and EPB terpolymers resins of the skin layers (A and E) may have a melt flow rate in the range of about 4 to 10 with a density of about 0.9 g/cc and a melting point or less than 140° C., for example, in the range of about 100° C. to 140° C.

Skin layers (A and E) may also be made from a polyethylene. Polyethylene may be a linear low density polyethylene (LLDPE), a linear high density polyethylene (HDPE) or a non-linear polyethylene (LDPE). These polymers may have a melt index of 1 to 10. LLDPE may be polymerized using a metallocene-based catalyst system. Low density polyethylene may have a density of 0.88 to 0.93 g/cc, while the linear materials may have a density as high as 0.94 g/cc, usually in the range 0.90-0.94 g/cc, e.g., 0.918 to 0.921 g/cc, with a melt index from about 1 to about 10. Linear low density polyethylene may be derived from ethylene together with other higher comonomers such as hexene-1 or octene-1. Linear high density polyethylene (HDPE) may have a density as high as 0.97 g/cc, usually in the range from 0.940 g/cc to about 0.97 g/cc, and more preferably from 0.955 to 0.965 g/cc, with a melt index from about 1 to 10.

Skin layers (A and E) may also be formed from a mixture of polyolefin polymers. For example, one or more skin layer may be made from a mixture of ethylene-propylene-butene-1 terpolymer and low density polyethylene (LDPE). For example, skin layer (A and E) may comprise 85 to 95 wt %, say 90 wt %, of ethylene-propylene-butene-1 terpolymer and 5 to 15 wt %, say 10 wt % low density polyethylene (LDPE).

Skin layers (A and E) may also be formed from copolymers and terpolymers described above as polymeric modifier for core layer C. Skin layer E may also be made from a polyolefin homopolymer, such as polyethylene or polypropylene.

Skin layers (A and E) may have a thickness in the range of from about 0.2 to 8 microns, preferably from 0.5 to 4 microns, and more preferably from 1 to 2 microns.

Skin Layer Additives

Either or both of the skin layers (A and E) may include one or more antiblock agents. These antiblock agents include inorganic particles, such as clays, talc, glass, and others. One antiblock additive may be used alone, or different sizes and shapes may be blended to optimize machinability. The major proportion of the particles, for example, more than half, may be of such a size that a significant portion of their surface area, will extend beyond the exposed surface of such skin layer (A and E). Suitable antiblocks include, but are not limited to, fully cross-linked non-meltable polymethyl methacrylate (PMMA) particles, such as EPOSTAR® MA-1002 from Nippon Shokubi of Osaka, Japan, or silica (SiO2) particles, such as SYLOBLOC 44 from W. R. Grace of Spartanburg, S.C., and SHEOSTAR® from Nippon Shokubi, or fully cross-linked or non-meltable polysiloxane micro-spheres, such as TOSPEARL® T120A, from Silicone Company, Ltd. of Tokyo, Japan. Partially cross-linked polysiloxane particles, which release non-cross-linked liquid silicone under stress, as described in U.S. Pat. No. 5,840,419, may also be used. The solid antiblock may be incorporated into the layer in an amount ranging from about 0.1 to about 0.5% by weight, preferably from about 0.15 to about 0.30% by weight, based on the entire weight of the skin layer.

Either or both of skin layers (A and E) may include a silicone based lubricant for improved slip properties. A conventional silicone oil or a silicone gum additive having a viscosity of 10,000 to 2,000,000 cSt. is contemplated at a loading level in the skin layer (A and E) of 0.2 to 3.0% by weight and preferably from 0.5% to 1.5% by weight.

Either or both of skin layers (A and E) may include a wax for lubricity. Amounts of wax range from 2 to 15 weight % based on the total weight of the layer. Any conventional wax useful in thermoplastic films is contemplated.

Other Core Layer Additives

The core layer C may optionally contain a small amount, e.g., up to about 3 wt % of one or more additives, such as antioxidants, slip additives, or antistatic additives.

Useful antistatic additives that may be used in amounts ranging from about 0.05 to about 3 wt %, based upon the weight of the layer, include alkali metal sulfonates, polyether-modified polydiorganosiloxanes, polyalkylphenylsiloxanes and tertiary amines. The antistatic agent may be glycerol monostearate (GMS) or a blend of GMS and tertiary amine.

Slip additives include higher aliphatic acid amides, higher aliphatic acid esters, waxes and metal soaps that may be used in amounts ranging from about 0.1 to about 2 wt % based on the total weight of the layer. A specific example of a fatty amide slip additive is erucamide.

Antioxidants, such as phenolic antioxidants, may be used in amounts ranging from about 0.1 wt % to about 2 wt %, based on the total weight of the layer. An example of an antioxidant is commercially available under the trademark IRGANOX 1010 by Ciba-Geigy of Basel, Switzerland.

The core layer C may include microscopic voids and/or 1-15, or 1-8, or 2-4 weight % of an opacifying agent, selected from one of iron oxide, carbon black, aluminum, TiO₂, talc, or combinations thereof.

Void-initiating particles, which may be added as filler to the polymer matrix material of the core layer C, may be any suitable organic or inorganic material which is incompatible with the core material at the temperature of biaxial orientation, such as polybutylene terephthalate (PBT), nylon, solid or hollow preformed glass spheres, metal beads or spheres, ceramic spheres, calcium carbonate, or combinations thereof.

The average diameter of the void-initiating particles may be from 0.1 to 10 microns. These particles may be of any desired shape or more preferably they may be substantially spherical in shape. This does not mean that every void is the same size. It means generally each void tends to be of like shape when like particles are used even though they vary in dimensions. These voids may assume a shape defined by two opposed and edge contacting concave disks. These void initiating particles will be present in the core layer C at<20 weight percent, or<15 weight percent, or<10 weight percent, typically in the range of from 1-10 weight percent, based on the total weight of the core layer C. The two average major void dimensions are greater than 30 microns. The void-initiating particle material, as indicated above, may be incompatible with the core material, at least at the temperature of biaxial orientation.

The core layer C has been described above as being a thermoplastic polymer matrix material within which is located a strata of voids. The voids create the matrix configuration. The term “strata” is intended to convey that there are many voids creating the matrix and the voids themselves may be oriented so that the two major dimensions are aligned in correspondence with the direction of orientation of the polymeric film structure. As described herein above, iron oxide in an amount of from 1-8 wt. %, preferably 2-4 wt. % and aluminum in an amount of from 0-1.0 wt. %, preferably 0.25 wt. %-0.85 wt. % are added to the core matrix. Carbon black may also be used in lieu of some or all of the iron oxide.

A typical void of the core layer C is defined as having major dimensions X and Y and minor dimensions Z, where dimension X is aligned with machine direction orientation, dimension Y is aligned with transverse direction orientation and dimension Z approximately corresponds to the cross-sectional dimension of the spherical particle which initiated the void.

Orientation conditions may be such that the X and Y dimensions of the voids of the core be major dimensions in comparison to the Z dimension. Thus, while the Z dimension generally approximates the cross-sectional dimension of the spherical particle initiating the void, X and Y dimensions may be significantly greater.

Polypropylene may be oriented at a temperature higher than its glass transition temperature. The temperature conditions may permit X and Y to be at least several multiples of the Z dimension, without void splitting. As indicated above, the matrix polymer and the void initiating particle may be incompatible and this term is used in the sense that the materials are two distinct phases. The spherical void initiating particles constitute a dispersed phase throughout the lower melting polymer which polymer will, ultimately, upon orientation, become a void-filled matrix with the spherical particles positioned somewhere in the voids.

The core layer C may also include specialty appearance-producing agents, such as coloring agents, phosphorescence producing agents, and reflective agents. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Suitable coloring agents include pigments and dyes. In one embodiment, pigments and dyes include organic pigments and dyes such as phthalocyanine, azo, condensed azo, azo lake, anthraquinone, perylene/perinone, indigo/thioindigo, isoindolinone, azomethineazo, dioxazine, quinacridone, aniline black, triphenylmethane and carbon black pigments; and inorganic pigments and dyes such as titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatment in a manner known per se in the art. Depending on the material to be colored, the coloring agent may be added with one or more of various additives such as organic solvents, film-forming resins (in not a large proportion), flame retardants, antioxidants, ultraviolet absorbers, plasticizers and surfactants. Colored compounded thermoplastics, which are commercially available may also be used with this invention, although direct addition of a dye or pigment to the extrusion is possible. In another embodiment colored compounded thermoplastic concentrates are used. (For example from Schulman of Akron, Ohio: Polybatch Blue P4021, Polybatch Blue P4535, Polybatch Red P50346, Polybatch Yellow P2214F, Polybatch Green P3510F, Polybatch Brown P1028F, and Polybatch Orange P10307; from Ampacet of Tarrytown, N.Y.: LR-92396 (blue), LR-92011 (blue), LR-92397 (green), LR-92398 (yellow), and LR-92010 (red); from Milliken of Spartanburg, S.C., Clear Tint Blue 9805, Clear Tint Red 9803, Clear Tint Amber 9808, and Clear Tint Green 9807.)

The core layer C may also include phosphorescence producing agents. Phosphorescent compounded thermoplastics that are commercially available may also be used with this invention, although direct addition of a dye or pigment to the extrusion is possible. Phosphorescent compounded thermoplastic concentrates are available for direct addition to the core layer C. For example masterbatches may include Schulman Phos 440, with the addition of a typical glow in the dark color such as Schulman Polybatch Greenglow P30335 or Polybatch Blueglow

The core layer C may also include a reflective agent. Suitable reflective agents include glass beads or microspheres, and cube-corner reflectors molded from glass and acrylic resins or oligomers. Cube-corner reflectors are disclosed in U.S. Pat. No. 6,120,636, which is incorporated herein by reference in its entirety.

Transition Layers (B and D)

The present film may have one or more transition layers (B and D). For example, from 1 to 6 transition layers interposed between the core layer C and the skin layers (A and E). The compositions of these transition layers may be the same or different (B and D), and may comprise any of the combination of components described for the core layer C. Transition layers may also be optionally referred to as additional core layers.

Transition layers (B and D) may have a thickness in the range of from about 1 to 10 microns, preferably 1.5 to 5 microns, and more preferably from 2 to 1 microns.

Coatings

Either or both of skin layers (A and E) may be coated with a suitable coating. One or more coatings may be applied to one or more skin layers (A and E) may include techniques such as coating with acrylic polymers, polyvinylidene chloride (PVdC), ethylene acrylic acid copolymers (EAA), ethylene methyl acrylate copolymers (EMA), or poly(vinyl)alcohol (PVOH, including but not limited to ethylene (vinyl)alcohol (EVOH) therewith).

Acrylic coatings may be derived from any of the terpolymeric compositions disclosed in U.S. Pat. Nos. 3,753,769 and 4,865,908, the contents of which are incorporated by reference herein. These coating compositions contain as a film forming component, a resin including an interpolymer of (a) from 2 to 15 or from 2.5 to 6 parts by weight of an alpha-beta monoethylenically unsaturated carboxylic acid selected including one or more of acrylic acid, methacrylic acid, or mixtures thereof, and (b) from 85 to 98 or from 94 to 97.5 parts by weight of neutral monomer esters, the neutral monomer esters including (1) methyl acrylate or ethyl acrylate and (2) methyl methacrylate. These interpolymer compositions are further characterized by including from 30 percent to 55 percent by weight of methyl methacrylate when the alkyl acrylate is methyl acrylate and from 52.5 percent to 69 percent by weight of methylmethacrylate when the alkyl acrylate is ethyl acrylate. As more fully described infra, such coating compositions may be applied to the films herein in a variety of ways including in the form of ammoniacal solutions.

Similarly useful are copolymeric coating compositions prepared from the foregoing neutral monomer esters. These coating compositions are advantageously applied to the film laminates in the form of emulsions.

The coating may also be based on any of the known and conventional polyvinylidene chloride (PVdC) compositions heretofore employed as coatings in film manufacturing operations, e.g., any of the PVdC materials described in U.S. Pat. Nos. 4,214,039; 4,447,494; 4,961,992; 5,019,447; and 5,057,177.

U.S. Pat. No. 5,230,963 discloses enhancing oxygen barrier of films by a method involving a coating, both of which are incorporated herein by reference, or with prior application of a primer layer to enhance adhesion of the PVdC coating layer to the film surface to which it is applied. Commercially available PVdC latexes having a vinylidene chloride content of at least 50% or from 75% to 92% may be employed. The PVdC may also be provided as a copolymer of vinylidene chloride and one or more other ethylenically unsaturated comonomers including alpha, beta ethylenically unsaturated acids such as acrylic and methacrylic acids; alkyl esters containing 1-18 carbon atoms of the acids, such as methylmethacrylate, ethyl acrylate, butyl acrylate, etc. In addition alpha, beta ethylenically unsaturated nitrites such as acrylonitrile and methacrylonitrile and monovinyl aromatic compounds such as styrene and vinyl chloride comonomers may be employed. Specific PVdC latexes contemplated include: 82% by weight vinylidene chloride, 14% by weight ethyl acrylate and 4% by weight acrylic acid. Alternatively a polymer latex including 80% by weight vinylidene chloride, 17% methyl acrylate and 3% by weight methacrylic acid may likewise be employed.

The vinyl alcohol polymers, which may be used as coatings, may be any commercially available material. For example, Vinol 125, 99.3+% super hydrolyzed polyvinyl alcohol, or VINOL 325, 98% hydrolyzed polyvinyl alcohol obtained from Air Products, Inc. of Allentown, Pa. Application of a PVOH coating is further described in U.S. Pat. No. 5,230,963, incorporated herein by reference.

Before applying the coating composition to the appropriate substrate, the upper surface of the film may be treated as noted herein to increase its surface energy. This treatment may be accomplished employing known techniques, such as, for example, film chlorination, i.e., exposure of the film surface to gaseous chlorine, treatment with oxidizing agents such as chromic acid, hot air or steam treatment, flame treatment and the like. Although any of these techniques is effectively employed to pretreat the film surface, another method of treatment is an electronic treatment method which includes exposing the film surface to a high voltage corona discharge while passing the film between a pair of spaced electrodes. After electronic treatment of the film surface, the coating composition is then applied thereto.

An intermediate primer coating may also be employed. In this case, the film may be first treated by one of the foregoing methods to provide increased active adhesive sites thereon and to the thus treated film surface there may be subsequently applied a continuous coating of a primer material. Such primer materials include, for example, epoxy, urethane and poly(ethylene imine) (PEI) materials. U.S. Pat. Nos. 3,753,769 to Steiner, 4,058,645 to Steiner and 4,439,493 to Hein et al., incorporated herein by reference, disclose the use and application of such primers. The primer provides an overall adhesively active surface for thorough and secure bonding with the subsequently applied coating composition and may be applied to the film by conventional solution coating means, for example, by mating roller application.

The coating composition may be applied to the film as a solution, one prepared with an organic solvent such as an alcohol, ketone, ester, and the like. However, since the coating composition may contain insoluble, finely divided inorganic materials which may be difficult to keep well dispersed in organic solvents, it is preferable that the coating composition be applied to the treated surface, as an aqueous solution in any convenient manner, such as by gravure coating, roll coating, dipping, spraying, and the like. The excess aqueous solution may be removed by squeeze rolls, doctor knives, and the like.

The film may be stretched in the machine direction, coated with the coating composition and then stretched perpendicularly in the transverse direction. In yet another embodiment, the coating may be carried out after biaxial orientation is completed.

The coating composition may be applied in such amount that there will be deposited upon drying a smooth, evenly distributed layer, generally on the order of from 0.01-0.2 mil (0.25-5 μl) thickness (equivalent to 0.2-3.5 g per 1000 sq. in. of film). Generally, the coating will be present from 1 to 25 wt % or 7 to 15 wt % of the entire coated film composition, based on the total weight of the multilayer film. The coating on the film may subsequently be dried by hot air, radiant heat or by any other convenient means.

Metallizing

Either or both of skin layers (A and E) may be metallized. Such metallization may include vacuum metallization through deposition of a metal selected from the group consisting of aluminum, gold and silver. For example, the thickness of a vacuum deposited aluminum layer is typically in the range of from about 50 to 2000 angstroms and preferably in the range of 200 to 1000 angstroms.

Method of Manufacture

Films with compositions of matter within the ranges specified above may be formed by coextruding the thermoplastic polymer-containing core layer C together with the skin layers (A and E) through a flat sheet extruder die at a suitable extrusion temperatures, casting the film onto a cooling drum and quenching the film. The sheet may then be stretched about 4 to 7 times in the machine direction (MD) between rolls, and then stretched about 6 to 11 times in the transverse direction (TD) in a tenter. The film may be cast and stretched in a manner such that skin layer (A and E), optionally including an antiblock agent, is contacted with the casting drum and the MD stretching rolls. The film may then be wound onto a reel.

Optionally, one or both of the external surfaces of the skin layers (A and E) may be coated or flame or corona treated before winding. The film may be treated by standard process methods to increase surface tension. Corona discharge treatment, flame treatment, or gas plasma treatment are suitable methods for increasing the surface tension of the film.

The core layer C may represent about 70 to about 95 percent of the thickness of the total multilayer polymeric film.

The temperature of the MD stretching should be sufficiently low to result in the desired shrink characteristics of the film. This temperature may be 105° C. or less, e.g., 90° C. or less, e.g., even 75° C. or less, depending upon the components selected to form the film. The process utilizes longitudinal (MDO) stretching temperatures from below 75° C., up to 105° C. with machine direction stretch ratios (MDX) of four to seven times. Transverse stretch ratios (TDX) may be between 6 and 11 times at temperatures below 145° C. A non-shrink version of the film may be achieved by reducing the MDX and utilizing normal transverse direction stretching and annealing temperatures.

The lower than conventional longitudinal (MDO) processing temperature allows for the use of low melting point skin polymers which may be used to lower seal initiation temperatures or improve hermetic seal properties. The combination of hydrocarbon resin and resin modifier in the core layer results in film that maintains improved mechanical properties (i.e., stiffness), especially suited for high-speed packaging.

The present invention makes it possible to develop novel, economical, heat sealable BOPP films with lower than conventional seal initiation temperatures. Such films may be suitable for packaging applications requiring high machine direction and transverse direction shrinkage at elevated temperature. Alternatively, films may be produced at lower stretching ratios in the machine and transverse directions and higher transverse direction stretching and annealing temperature to produce typical BOPP film shrinkage values with lower than conventional seal initiation temperatures.

The present film may possess excellent gloss and haze characteristics. The gloss may be at least 90, for example, as determined by ASTM D 2457-70. The haze may be less than 2, for example, as determined by ASTM D1003-61.

The following examples illustrate the present invention without limiting the scope thereof.

TEST METHODS

Softening point of hydrocarbon resin via the ball and ring method=ASTM D6493-99

Gauge or thickness=ASTM D 4321

Tensile properties (ultimate strength, modulus and elongation)=ASTM D 882

Dimensional stability (also referred to as shrink or shrinkage)=ASTM D 1204

Haze=ASTM D 1003

Gloss=ASTM D 2457

COF (also referred to as coefficient of friction) ASTM D 1894

WVTR (also referred to as water vapor transmission)=ASTM F 1249

OTR (also referred to as oxygen transmission)=ASTM D 3985

Optical density=ANSI/NAPM IT2.19

Crimp seal strength, and minimum sealing temperature (MST)=ASTM F 88

Treatment level (also referred to as treat or wetting tension)=ASTM D 2578

### EXAMPLES

### Illustrative Example No. 1

### Clear Biaxially Shrinkable Heat Sealable Film

A 5 layer film structure is prepared with the following orientation process conditions: longitudinal stretching temperature of 79 to 85° C.; transverse stretching temperature of 141, 161, and 163° C.; longitudinal stretch ratio of 5.0 to 5.4 times; and transverse stretch ratio of 8 times. The core layer and two transition layers of the film are made of the same material.

A film is prepared with the following structure:

Polyolefinic copolymer or terpolymer which is
compounded with an effective amount of anti-blocking
agent and lubricants
Polypropylene +8.9% hydrocarbon +12.5%
polyethylene polypropylene copolymer
Polypropylene +8.9% hydrocarbon +12.5%
polyethylene polypropylene copolymer
Polypropylene +8.9% hydrocarbon +12.5%
polyethylene polypropylene copolymer
Polyolefinic copolymer or terpolymer which is
compounded with an effective amount of anti-blocking
agent and lubricants

Five layer film-a/b/c/d/e

Core 5% EP copolymer+2.4% hydrocarbon (softening point 138° C.)

Longitudinal stretching section temperatures ° C.

| Mdo x1 | Mdo x2 | Mdo x3 | Mdo x4 | Mdo x5 | Mdo x6 | Mdo x7 | Mdo x8 | mdo x9 | Mdo x10 |
|---|---|---|---|---|---|---|---|---|---|
| 88 | 93 | 93 | 93 | 93 | 99 | 102 | 96 | 89 | 89 |

Sealable skins with no treatment.

The following regression of 17 variables illustrates the ability of the hydrocarbon to regain the mechanical property of modulus lost when a modifier is added.

Spp=syndiotactic polypropylene

Pb/pe=Polybutylene/polyethylene copolymer

Pe/pp=polyethylene/polypropylene copolymer

Hydrocarbon=138° C. softening point

The regression equation is:

Longitudinal MODULUS psi = 263129 − 1368 SPP − 2943
Pb/pe − 858 pe/pp + 3442 hydrocarbon

| Predictor | Coefficient | Std. Dev. | t-value | Probability |
|---|---|---|---|---|
| Constant | 263129 | 15975 | 16.47 | 0.000 |
| Spp | −1368.0 | 878.5 | −1.56 | 0.142 |
| Pb/pe | −2943 | 1606 | −1.83 | 0.088 |
| Pe/pp | −858 | 1261 | −0.68 | 0.507 |
| Hydrocarbon | 3441.6 | 920.0 | 3.74 | 0.002 |

5 layer films a/b/c/d/e (using 5 extruders) were produced using the following skin layer resin formulations (see table for combinations used):

1. Affinity 1845 metallocene LLDPE

2. Opp 12078=Union Carbide DS4-D05 (butene-1/polypropylene copolymer) with 2000 ppm Tospearl T145+2000 ppm Grace Sylobloc 44 antiblocks

3. Opp 12079=Union Carbide DS4-D05 (butene-1/polypropylene copolymer) with 2000 ppm Tospearl T145 antiblock+2000 ppm Grace Sylobloc 44 antiblock+1.2% Dow silicone oil (30,000 centistoke viscosity)

4. Opp 12080=Chisso 7300 (ethylene butene-1/polypropylene terpolymer) with 2000 ppm Tospearl T145 antiblock+2000 ppm Grace Sylobloc 44 antiblock+1.2% Dow silicone oil (30,000 centistoke viscosity)

Films exhibited high shrink values in both the machine and transverse directions, outstanding optical properties as measured by haze and gloss, lower than typical WVTR, excellent sealability and slip properties, and exceptional processability on a conventional BOPP tentering line. See the table below for details.

| Roll no. | 2 | 3 | 7 | 8 | 9 |
|---|---|---|---|---|---|
| Thickness (microns) | 16.5 | 15.0 | 16.3 | 21.3 | 20.8 |
| WVTR g/100 in 2 · day | 0.41 | 0.46 | 0.47 | 0.33 | 0.36 |
| WVTR g · mil/100 in 2 · day | 0.27 | 0.27 | 0.3 | 0.28 | 0.29 |
| Haze % | 1.2 | 1.3 | 1.7 | 1.3 | 1.1 |
| Gloss in (45 deg) | 90.6 | 89.7 | 91 | 93.5 | 93.2 |
| Gloss out (45 deg) | 88.9 | 88.1 | 91.2 | 93.2 | 93.3 |
| Modulus MD (Kpsi) | 321 | 316 | 284 | 295 | 296 |
| Modulus TD (Kpsi) | 675 | 664 | 595 | 561 | 534 |
| MST out (C.) | 107.7 | 106.9 | 103.3 | 101.4 | 101.8 |
| MST in (C.) | 104.6 | 101.6 | 108.4 | 83.0 | 87.1 |
| MST in to out (C.) | | | | 97.6 | 97.1 |
| CoF out (unitless) | 0.27 | 0.27 | 0.36 | 0.44 | 0.48 |
| CoF in (unitless) | 0.22 | 0.24 | 0.27 | 0.37 | 0.3 |
| CoF in-out (unitless) | 0.28 | 0.27 | 0.32 | 0.59 | 0.42 |
| MD dim · stabs. % @ 107 C. | −3.7 | −3.3 | −2.7 | −3.7 | −3 |
| TD dim · stabs. % @ 107 C. | −7 | −6.7 | −3.7 | −4.3 | −3 |
| MD dim · stabs. % @ 121 C. | −6.3 | −5.7 | −4 | −5 | −5 |
| TD dim · stabs. % @ 121 C. | −6.3 | −5.7 | −4 | −5 | −5 |
| MD dim · stabs. % @ 135 C. | −9.7 | −8 | −7 | −7.7 | −7 |
| TD dim · stabs. % @ 135 C. | −24 | −23 | −13 | −13 | −10.7 |
| MDO stretch temp (C.) | 85 | 85 | 79 | 79 | 79 |
| TDO stretch (C.) | 141 | 141 | 161 | 161 | 163 |
| TDO anneal (C.) | 146 | 146 | 146 | 146 | 163 |
| % hydrocarbon | 10 | 10 | 5 | 5 | 5 |
| % EP copolymer (AtoFina | 14 | 14 | 5 | 5 | 5 |
| 8573) | | | | | |
| MDX | 5.2 | 5.2 | 5 | 5.4 | 5.4 |
| Line speed (mpm) | 50.3 | 50.3 | 62.7 | 61.8 | 61.8 |
| Water bath side skin resin | Chisso | Chisso | Opp12078 | opp12078 | Opp12078 |
| (outside) | Hf3408A | Hf3408A | | | |
| Cast roll side skin resin | Chisso | Chisso | Opp12079 | Dow | Dow |
| (inside) | 7703 | 7703 | | affinity | affinity |
| | | | | 1845 | 1846 |
| MDO z1 (C.) | 99 | 99 | 93 | 93 | 93 |
| MDO z2 (C.) | 99 | 99 | 93 | 74 | 93 |
| MDO z3 (C.) | 85 | 85 | 93 | 93 | 93 |
| MDO z4 (C.) | 85 | 85 | 93 | 74 | 74 |
| MDO z5 (C.) | 85 | 85 | 82 | 82 | 74 |
| MDO z6 (C.) | 85 | 85 | 82 | 74 | 74 |
| MDO z7 (C.) | 85 | 85 | 77 | 79 | 79 |
| MDO z8 (C.) | 85 | 85 | 83 | 74 | 74 |
| MDO z9 (C.) | 85 | 99 | 88 | 82 | 82 |
| MDO z10 (C.) | 85 | 99 | 99 | 74 | 74 |

“MDX” refers to the machine direction stretch ratio and is measured by dividing the first fast roll speed by the last slow roll speed in the machine direction orienter (MDO).
“MST” refers to minimum sealing temperature and is the minimum heat sealing temperature at which a seal strength of 200 grams/inch is achieved.

### Illustrative Example No. 2

### White Opaque Biaxially Shrinkable Heat Sealable Film

These are 5-layer cavitated white opaque OPP shrink films with polybutylene terephthalate used as the cavitating agent. Results indicate a white opaque cavitated film with overall shrinkages (MD and TD combined) of over 20% with exceptional processability on a conventional BOPP tentering line.

| | Roll no. | Bw01110-01 | Bw01110-02 | Bw01110-04 |
|---|---|---|---|---|
| Shrinkage | Md dim stabs 135 C. | −8.7 | −10 | −10.7 |
| % | Td dim stabs 135 C. | −13.3 | −15.3 | −16.3 |
| Stretch | Film thickness microns | 23 | 23 | 23 |
| Conditions | MDX | 5.5 | 6.2 | 6.2 |
| | MDO TEMPS C. | 99 | 99 | 99 |
| | TDO PREHEAT C. | 171 | 171 | 167 |
| | STRETCH C. | 160 | 160 | 156 |
| | ANNEAL C. | 149 | 149 | 149 |
| Outside skin | Treatment outside | none | None | None |
| layer | Waterbath side skin resin | Chisso 7502 | Chisso 7502 | Chisso 7502 |
| | (outside) | | | |
| | Microns | 0.76 | 0.76 | 0.76 |
| Tie layer | Resin type/thickness | AtoFina3371/1.3 | AtoFina3371/1.3 | AtoFina3371/1.3 |
| | microns | | | |
| Core layer | AtoFina 3371 | 73% | 73% | 61% |
| | AtoFina 8573 | 5% | 5% | 5% |
| | CELANESE 1300A | 10% | 10% | 10% |
| | Exxon 6114e1 | 12% | 12% | 24% |
| Tie layer | Resin type/thickness | AtoFina3371/1.3 | AtoFina3371/1.3 | AtoFina3371/1.3 |
| | microns | | | |
| Inside skin | Skin resin (inside) | Chisso 7703 | Chisso 7703 | Chisso 7703 |
| layer | Corona TREAT in 38 | yes | Yes | Yes |
| | DYNES | | | |
| | Thickness microns | 0.89 | 0.89 | 0.89 |
| | Objective | Shrink White | Shrink White | Shrink White |

### Illustrative Example No. 3

### Clear Acrylic Coated Biaxially Shrinkable Film

A 3 layer coextruded film produced with the shrink core formulation and process methods described in illustrative Example No. 1 was coated on both A and E skin layers with acrylic coating. Oven drying temperatures were approximately 93° C. Both a precoat and acrylic topcoat was applied to both skin layers. Overall shrinkage levels of approximately 20% was retained after coating the film with 2 passes through the coater. The coater utilized only has the capability to coat one side of the films at a time, and hence necessitated two passes through the coating process to achieve a 2-side coated film. This acrylic coated biaxially shrinkable film was used in a pilot tobacco packaging trial which requires sealability on both sides to wrap packs. Packs were successfully wrapped on a Scandia 708 box wrapper. The results show an acrylic coated film that retained excellent shrinkage properties after coating.

| | | |
|---|---|---|
| Shrinkage % | Md dim stabs 135 C. | −9.7 |
| | Td dim stabs 135 C. | −10.25 |

### Illustrative Example No. 4

### Metallized Biaxially Shrinkable Film

A roll of 23 micron clear biaxially shrinkabe heat sealable OPP film was vacuum metallized with aluminum to an optical density of approximately 2.4 on the corona treated skin layer. Barrier properties to moisture and oxygen as well as shrinkage were measured after metallization with the results indicated below. The test clearly indicates that the metallized shrink film retained excellent shrinkage properties after metallization as well as having oxygen and water vapor barrier properties typical of a metallized OPP film.

| | | |
|---|---|---|
| WVTR | 90% RH g/24 hr/100 sq. in | Rep 1 = 0.042 |
| | | Rep 2 = 0.011 |
| Oxygen Transmission | cc/24 hrs/100 sq. in. | Rep 1 = 8.32 |
| TO₂ | | Rep 2 = 6.41 |
| | | Rep 3 = 3.21 |
| Shrinkage % | Md dim stabs 135 C. | −9 |
| | Td dim stabs 135 C. | −11.4 |
| Stretching Conditions | FILM thickness microns | 23 |
| | MDX | 5.3 |
| | MDO TEMPS (C.) | 100 |
| | TDO PREHEAT (C.) | 188 |
| | STRETCH (C.) | 156 |
| | ANNEAL (C.) | 152 |
| Outside Skin Layer | treat out | None |
| | Resin type | Chisso 7502 |
| | Thickness (Microns) | 0.76 |
| Core | AtoFina 3355Z | 76% |
| | AtoFina 8573 | 12% |
| | Exxon 6114E2 | 12% |
| Inside skin layer | Resin type | Chisso 7703 |
| | Corona TREAT to 38 DYNES | Yes |
| | Thickness (Microns) | 0.84 |
| Metal deposition | Optical density | 2.41 |
| | Objective | Shrink |
| | | Metallized |

“Rep” signifies repetition for when more than one measurement point collected.

We claim:

1. A multi-layer polymeric film comprising:
(a) a first skin layer having a first side and a second side;
(b) at least one core layer comprising polypropylene, a polymeric modifier, a hydrocarbon resin, and appearance additive, wherein the core layer has a first side and a second side and the first side of the core layer is adjacent to the second side of the first skin layer; and
(c) a second skin layer having a first side and a second side wherein the first side of the second skin layer is adjacent to the second side of the core layer.

2. The film of claim 1, wherein the appearance additive of the core layer is selected from the group consisting of:
i) an opacifying agent selected from the group consisting of iron oxide, carbon black, aluminum, TiO₂, and talc, said opacifying agent being present in said core layer in an amount ranging from about 1 wt % to about 15 wt %, based on the total weight of the core layer;
ii) a cavitating agent selected from the group consisting of polybutylene terephthalate, nylon, solid glass spheres, hollow glass spheres, metal beads, metal spheres, ceramic spheres, and CaCO₃, said cavitating agent being present in said core layer in an amount ranging from about 1 wt % to about 20 wt %, based on the total weight of the core layer, said cavitating agent having a mean particle size in the range of from 0.1 micron to 10 microns;
iii) a specialty appearance-producing agent selected from the group consisting of coloring agents, phosphorescence producing agents, reflective agents, and mixtures thereof; and
iv) combinations thereof.

3. The film according to claim 1, wherein the core layer comprises from about 2 percent by weight to about 10 percent by weight of polymeric modifier and from about 2 percent by weight to about 10 percent by weight of hydrocarbon resin, based on the total weight of the core layer.

4. The film according to claim 1, wherein at least one outermost surface of the film is surface treated with corona treatment, flame treatment, or plasma treatment.

5. The film according to claim 1, further comprising:
a coating layer applied on at least one outermost surface of the film, wherein the coating layer is selected from the group consisting of acrylic, epoxy, PVdC, EMA, EAA, PVOH, EVOH, and blends thereof.

6. The film of claim 5, further comprising:
an intermediate primer coating layer interposed between the coating layer and the at least one outermost layer of the film, wherein the intermediate primer coating layer is selected from the group consisting of epoxy, urethane, and polyethylene imine.

7. The film of claim 1, wherein at least one outermost surface of the film is vacuum metallized with aluminum.

8. The film of claim 1 having greater than 20% overall area reduction shrinkage at 135° C.

9. A multi-layer polymeric film comprising:
(a) a first skin layer having a first side and a second side;
(b) at least one core layer comprising polypropylene, a polymeric modifier, a hydrocarbon resin, wherein the core layer has a first side and a second side and the first side of the core layer is adjacent to the second side of the first skin layer; and
(c) a second skin layer having a first side and a second side wherein the first side of the second skin layer is adjacent to the second side of the core layer.
(d) a coating layer applied on at least one outermost surface of the film.

10. The film of claim 9, wherein the coating layer is selected from the group consisting of acrylic, epoxy, PVdC, EMA, EAA, PVOH, EVOH, and blends thereof.

11. The film of claim 10, further comprising:
an intermediate primer coating layer interposed between the coating layer and the at least one outermost layer of the film, wherein the intermediate primer coating layer is selected from the group consisting of epoxy, urethane, and polyethylene imine.

12. The film of claim 9, wherein at least one of the coating layers is aluminum.

13. The film of claim 9, wherein the core layer comprises from about 2 percent by weight to about 5 percent by weight of polymeric modifier and from about 2 percent by weight to about 5 percent by weight of hydrocarbon resin, based on the total weight of the core layer.

14. The film of claim 9 having greater than 20% overall area reduction shrinkage at 135° C.

15. An multilayer, polymeric film comprising:
(a) a core layer comprising isotactic polypropylene, a polymeric modifier, and a hydrocarbon resin; wherein the core layer comprises an interior of the film;
(b) a first transition layer exterior to the core layer and on one side of the core layer, wherein the first transition layer is selected from the group consisting of isotactic polypropylene, EP random copolymer, PB copolymer, EPB terpolymer, hydrocarbon resins, and mixtures thereof;
(c) a first skin layer exterior to both the core layer and the first transition layer and on the same side of the core layer as the first transition layer, the first skin layer comprising a material selected from the group consisting of isotactic polypropylene, EPB terpolymer, EP copolymer, PB copolymer, metallocene catalyzed polyethylene, HDPE, LLDPE, LDPE, and mixtures thereof; and
(d) a second skin layer exterior to the core layer and on a side of the core layer opposite the first transition layer and the first skin layer, wherein the second skin layer comprises a material selected from the group consisting of isotactic polypropylene, EPB terpolymer, EP copolymer, PB copolymer, metallocene catalyzed polyethylene, HDPE, LLDPE, LDPE, and mixtures thereof.

16. The film of claim 15, wherein the polymeric modifier in said core layer is selected from the group consisting of atactic polypropylene, syndiotactic polypropylene, ethylene-propylene copolymer, propylene-butylene copolymer, and ethylene-propylene-butylene terpolymer.

17. The film of claim 15, wherein the hydrocarbon resin in the core layer is hydrogenated hydrocarbon resin, or saturated alicyclic resin.

18. The film of claim 15, wherein the core layer comprises from about 2 percent by weight to about 10 percent by weight of polymeric modifier and from about 2 percent by weight to about 10 percent by weight of hydrocarbon resin, based on the total weight of the core layer.

19. The film of claim 15 further comprising a second transition layer interposed between said core layer and said second skin layer.

20. The film of claim 19, wherein said second transition layer is selected from a group consisting of isotactic polypropylene, EP random copolymer, PB copolymer, EPB terpolymer, hydrocarbon resins, and mixtures thereof.

21. The film of claim 15, wherein said isotactic polypropylene has an isotacticity level of about 87% to 93%.

22. The film of claim 15, wherein the core layer further comprises a cavitating agent, wherein the cavitating agent is selected from the group consisting of polybutylene terephthalate, and CaCO₃, said cavitating agent being present in said core layer in an amount ranging from about 1 wt % to about 10 wt %, based on the total weight of the core layer, said cavitating agent having a mean particle size in the range of from 0.1 micron to 10 microns.

23. The film of claim 15, wherein the first transition layer further comprises an appearance additive, wherein the appearance additive is selected from the group consisting of:
i) an opacifying agent selected from the group consisting of iron oxide, carbon black, aluminum, TiO₂, and talc, said opacifying agent being present in an amount ranging from about 1 wt % to about 10 wt %, based on the total weight of the first transition layer; and
ii) a specialty appearance-producing agent selected from the group consisting of coloring agents, phosphorescence producing agents, reflective agents, and mixtures thereof.

24. The film of claim 19, wherein said second transition layer further comprises an appearance additive, wherein the appearance additive is selected from the group consisting of:
i) an opacifying agent selected from the group consisting of iron oxide, carbon black, aluminum, TiO₂, and talc, said opacifying agent being present in said second transition layer in an amount ranging from about 1 wt % to about 10 wt %, based on the total weight of the second transition layer; and
ii) a specialty appearance-producing agent selected from the group consisting of coloring agents, phosphorescence producing agents, reflective agents, and mixtures thereof.

25. The film of claim 15, wherein at least one of the first skin layer and the second skin layer further comprises a silicone based lubricant.

26. The film of claim 15, wherein at least one of the first skin layer and the second skin layer further comprises an antiblock agent.

27. The film according to claim 15, wherein at least one outermost surface of the film is treated by a procedure selected from a group consisting of corona treatment, flame treatment, and plasma treatment.

28. The film of claim 15, wherein at least one outermost surface of the film is coated with a coating layer selected from the group consisting of acrylic, PVdC, PVOH, and blends thereof.

29. The film of claim 28, wherein an intermediate primer coating layer selected from the group consisting of epoxy, urethane and polyethylene imine is interposed between said coating layer and said outermost surface of the film.

30. The film of claim 15, wherein at least one outermost surface of the film is vacuum metallized with aluminum.

31. The film of claim 15 having greater than 20% overall area reduction shrinkage at 135° C.

32. A method for manufacturing the multi-layer heat sealable polymeric film of claim 15, said method comprising the steps of:
(a) coextruding a multi-layer melt; i) the first skin layer comprising a heat sealable polymer with a melting point below 120° C.; ii) a core layer comprising isotactic polypropylene, a polymeric modifier, and a hydrocarbon resin; iii) a first transition layer interposed between the first skin layer and the core layer, the first transition layer comprising isotactic polypropylene, EP random copolymer, PB copolymer, EPB terpolymer, and hydrocarbon resins; and a iv) second skin layer comprising a heat sealable polymer with a melting point below 120° C. to form a multi-layer melt, the second skin layer positioned on a side of the core layer opposite the first skin layer;
(b) quenching the multi-layer melt on a water-cooled casting roll to form a multi-layer cast sheet;
(c) stretching said multi-layer cast sheet in the machine direction (MD) at roll temperatures below 120° C. from about 4 to about 7 times in the machine direction (MD) to form an MD stretched multi-layer heat sealable polymeric film;
(d) stretching said MD stretched multi-layer heat sealable film the film in the transverse direction (TD) from about 7 to about 11 times in the transverse direction (TD) to form a biaxially stretched untreated multi-layer heat sealable polymeric film;
(e) thereafter surface treating at least one outermost surface of said biaxially stretched untreated multi-layer heat sealable polymeric film with a surface treating procedure selected from the group consisting of corona treatment, flame treatment, and plasma treatment, to form the multi-layer heat sealable polymeric film; and
(f) winding said multi-layer heat sealable polymeric film onto a reel.

33. The method of claim 32 further comprising the step of coating at least one outermost surface of said multi-layer heat sealable polymeric film.

34. The method of claim 33, wherein the step of coating is performed between the step of MD stretching and the step of TD stretching.

35. The method of claim 32 further comprising the step of vacuum metallizing with aluminum at least one outermost surface of said multi-layer heat sealable polymeric film.

36. The method of claim 32, further comprising coextruding within the core layer of step (a) a cavitating agent selected from the group consisting of polybutylene terephthalate, and CaCO₃.

37. The method of claim 32, further comprising coextruding within the first transition layer of step (a) an appearance additive selected from the group consisting of TiO₂, coloring agents, phosphorescence producing agents, reflective agents, and mixtures thereof.

38. The method of claim 32, wherein step (c) further comprises stretching the multi-layer cast sheet in the machine direction (MD) at roll temperatures below 105° C. to form an MD shrinkable multi-layer heat sealable polymeric film.

39. The method of claim 32, wherein step (c) further comprises stretching the multi-layer cast sheet in the machine direction (MD) at roll temperatures below 90° C. to form an MD shrinkable multi-layer heat sealable polymeric film.

40. The method of claim 38, wherein step (d) further comprises stretching said MD shrinkable multi-layer heat sealable film in the transverse direction (TD) at a temperature below 145° C. to form a biaxially shrinkable untreated multi-layer heat sealable polymeric film.

41. The method of claim 39, wherein step (d) further comprises stretching said MD shrinkable multi-layer heat sealable film in the transverse direction (TD) at a temperature below 145° C. to form a biaxially shrinkable untreated multi-layer heat sealable polymeric film.
